(19) United States
(12) Patent Application Publication
(10) Pub. No.: US 2018/0119713 A1
(43) Pub. Date: May 3, 2018

(54) SYSTEM AND METHOD FOR HEALTH MONITORING OF HYDRAULIC PUMPS

(71) Applicant: Sikorsky Aircraft Corporation, Stratford, CT (US)

(72) Inventors: Jared Kloda, Warriors Mark, PA (US); Matthew J. Smith, Rochester, NY (US)

(21) Appl. No.: 15/564,728

(22) PCT Filed: Apr. 8, 2016
(86) PCT No.: PCT/US16/26628

§ 371 Date: Oct. 5, 2017

Related U.S. Application Data
(60) Provisional application No. 62/145,149, filed on Apr. 9, 2015.

(51) Int. Cl. F15B 19/00; B64C 13/36; F04B 51/00

(52) U.S. Cl. CPC F15B 19/005; B64C 13/36; F04B 51/00; F15B 2211/857; F04B 2205/05; F04B 2205/11; F15B 2211/20546; F04B 2201/0802

(57) ABSTRACT

A method of monitoring health of a hydraulic pump includes identifying, from performance data received from a sensor coupled to a hydraulic system, intervals of steady state and transient state operation. Dynamic element indicators are determined using data from the interval of steady state operation. Performance indicators are determined using data from both the interval of steady state operation and the interval of transient state operation. One or more state flags are set using the dynamic element indicators and the performance indicators.

### CROSS REFERENCE TO RELATED APPLICATIONS

This application claims the benefit of U.S. Provisional Patent Application Ser. No. 62/145,149, filed Apr. 9, 2015, and entitled SYSTEM AND METHOD FOR HEALTH MONITORING OF HYDRAULIC PUMPS, which is incorporated herein by reference in its entirety.

### STATEMENT OF GOVERNMENT RIGHTS

This invention was made with government support under Contract No. W911W6-10-2-0006 awarded by the Army. The government has certain rights in the invention.

### BACKGROUND OF THE INVENTION

### 1. Field of the Invention

The present disclosure relates to hydraulic systems, and more particularly to hydraulic system pump health monitoring.

### 2. Description of Related Art

Vehicles like aircraft commonly include hydraulic systems for circulating pressurized fluid to fluid-powered devices. Such hydraulic systems typically include a distribution system and a pump for pressurizing fluid flowing through the distribution system. The pump generally receives fluid from the distribution system, increases pressure of the fluid, and returns the fluid at a higher pressure to the distribution system. The distribution system routes the pressurized fluid to one or more fluid-powered devices, which respectively convert the fluid pressure to mechanical work, and thereafter return the fluid at a lower pressure to the distribution system. The distribution system routes the returned fluid to the pump, which re-pressurizes the fluid, and returns the pressurized fluid to the distribution system. In some systems, incipient changes in the performance of the pump can be difficult to detect. Therefore, out of an abundance of caution, such pumps may be replaced well before the performance of the pump changes.

Such conventional methods and systems have generally been considered satisfactory for their intended purpose. However, there is still a need in the art for improved systems and methods for determining pump health. The present disclosure provides a solution for this need.

### SUMMARY OF THE INVENTION

A method of monitoring health of a hydraulic pump includes identifying, from performance data received from a sensor coupled to a hydraulic system, intervals of steady state and transient state operation. Dynamic element indicators are determined using data from the interval of steady state operation. Performance indicators are determined using data from both the interval of steady state operation and the interval of transient state operation. One or more state flags are set using the dynamic element indicators and the performance indicators.

In certain embodiments the method can include receiving parametric data associated with a hydraulic pump for a hydraulic system of a vertical take-off and landing (VTOL) aircraft. Dynamic element indicators for dynamic elements of the hydraulic pump, such as a piston, shaft, motor, or other dynamic element of the hydraulic pump can be calculated using the received data. For example, the received data can include volumetric flow data, and the method can include identifying a constant flow rate window that is a sub-interval of the interval of steady state operation. The volumetric flow data can be filtered, and the method can include identifying the constant flow rate window using the filtered volumetric flow data.

In accordance with certain embodiments the received data can include temperature, flow, and pressure data, and the method can include filtering the temperature, flow, and pressure data. Determining the performance indicators can include using both the filtered temperature and filtered pressure data. The method can include calculating model-estimated pump output pressure and calculating a deviation between the model-estimated output pressure and the actual output pressure. It is contemplated that the method can include estimating output pressure based on volumetric flow data, and the performance indicators can be determined by comparing this estimation to the measured output pressure. The performance indicators can be checked against detection criteria, and a corresponding state flag can be set.

It is also contemplated that in certain embodiments the method can include subdividing the interval of steady state operation into a plurality of sub-intervals (windows) of predetermined duration. The received data can include both vibration data and dynamic pressure data, and the method can include converting the vibration and dynamic pressure data into frequency domain data, extracting frequency components from the vibration and dynamic pressure data that are associated with pump dynamic elements, and comparing the extracted frequency components against one or more predetermined frequency detection criteria. The comparison can be made using summary statistics, and determining the dynamic element indicators can include comparing one or more of the summary statistics against detection criteria that are statistics based. The data can include pump case temperature, and the method can include calculating a mean case temperature for comparison with temperature detection criteria.

A system for monitoring the health of a hydraulic component includes a processor, a memory, and at least one sensor. The processor is operatively associated with the sensor and is communicative with the memory. The memory has instructions recorded on it for executing one or more of the methods described above. A non-transitory, computer-readable medium with instructions recorded on it to cause a processor to execute the above method is also contemplated.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an exemplary embodiment of a vertical take-off and landing (VTOL) aircraft, showing a hydraulic system and a health monitoring system;

FIG. 2 is a schematic view of the hydraulic system of the VTOL aircraft of FIG. 1, showing a hydraulic pump and pump performance parameters sensors;

FIG. 3 is a schematic view of the health monitoring system of the VTOL aircraft of FIG. 1, showing a system memory having program modules for pump health monitoring;

FIG. 4 is a method of monitoring the health of a hydraulic pump, showing operations for determining performance indicators and dynamic element indicators for a pump employed by a hydraulic system;

FIG. 5 shows examples of data used by the method of FIG. 4 for determining the performance and dynamic element indicators, according to an embodiment;

FIG. 6 shows operations for determining the performance indicators of according to an embodiment; and

FIG. 7 shows operations for determining the dynamic element indicators of FIG. 4, according to an embodiment.

### DETAILED DESCRIPTION OF THE PREFERRED EMBODIMENTS

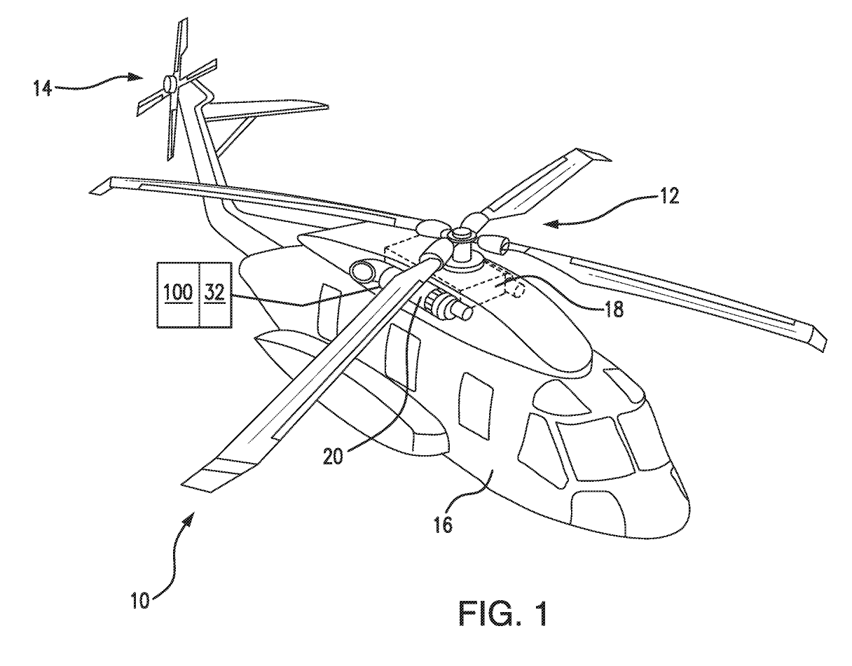

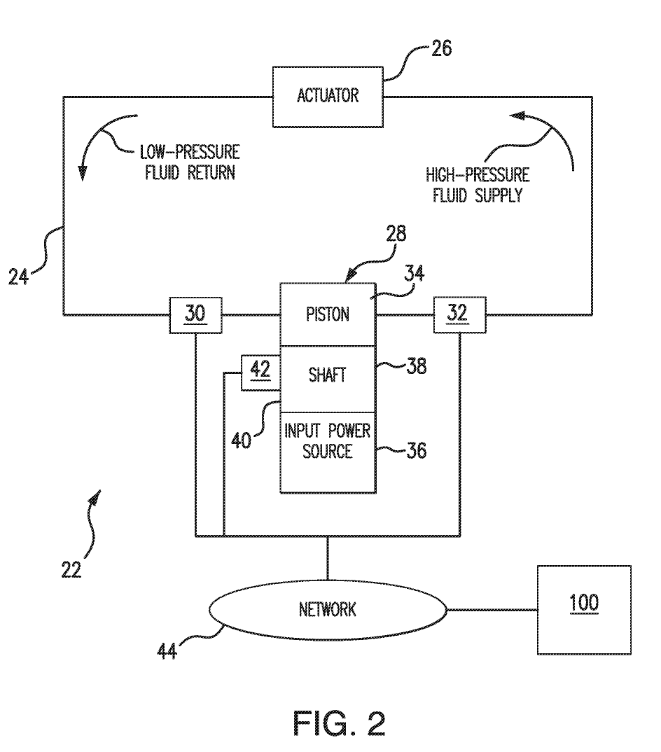

Reference will now be made to the drawings wherein like reference numerals identify similar structural features or aspects of the subject disclosure. For purposes of explanation and illustration, and not limitation, a partial view of an exemplary embodiment of a vertical takeoff and landing (VTOL) aircraft in accordance with the disclosure is shown in FIG. 1 and is designated generally by reference character 10. Other embodiments of VTOL aircraft in accordance with the disclosure, or aspects thereof, are provided in FIGS. 2-7, as will be described. The systems and methods described herein can be used for monitoring hydraulic systems, such as for monitoring the health of a hydraulic pump used in a flight control system for a VTOL aircraft.

VTOL aircraft 10 includes a main rotor system 12 and tail rotor system 14 supported by an airframe 16. Airframe 16 includes a gearbox 18 interconnecting an engine 20 with main rotor system 12 and tail rotor system 14. A hydraulic system 32 with a monitoring system 100 is operatively associated with engine 20 for receiving rotational energy from engine 20. Although a particular VTOL aircraft configuration is illustrated and described in the disclosed embodiment, other configurations and/or machines, such as high speed compound rotary wing aircraft with supplemental translational thrust systems, dual contra-rotating, coaxial rotor system aircraft, turbo-props, tilt-rotors and tilt-wing aircraft, will also benefit from the present invention.

With reference to FIG. 2, hydraulic system 22 is shown. Hydraulic system 22 includes a hydraulic circuit 24 with a hydraulic pump 28 and a fluid-powered device 26. Fluid-powered device 26 may be an actuator, such as an actuator operatively connected to flight control surface or other flight control device. Hydraulic pump 28 may include a variable displacement pump having a piston 34, shaft 38, and an input power source 36. Input power source 36 may be, for example, a motor or a transmission output shaft. Shaft 38 rotateably couples piston 34 to input power source 36. Piston 34 is disposed within a cylinder defined by a case 40 and reciprocates with a stroke of variable length to discharge pressurized, fluid into hydraulic circuit 24, and receives a return flow of reduced pressure hydraulic fluid therefrom. Hydraulic circuit 24 interconnects hydraulic pump 28 with fluid-powered device 26 such that fluid-powered device 26 receives pressurized fluid from hydraulic pump 28 and returns low pressure hydraulic fluid to hydraulic pump 28. Hydraulic pump 28 receives return fluid from hydraulic circuit 24, pressurizes the returned fluid, and supplies the pressurized fluid to fluid-powered device 26 via hydraulic circuit 24. Although illustrated herein as a positive displacement pump, it is to be understood and appreciated that hydraulic pump 28 may alternatively include a gear pump, a turbo pump, or a scroll pump by way of non-limiting example.

Hydraulic circuit 24 generally includes a plurality of sensors for providing data indicative of the performance and health of hydraulic system 22. In this respect, hydraulic circuit 22 includes a first sensor 32, a second sensor 30, and a third sensor 42. First sensor 32, second sensor 30, and third sensor 42 that are connected to hydraulic circuit 24 and/or hydraulic pump 28, and are communicative with health monitoring system 100 through a network 44. It is contemplated that one or more of first sensor 32, second sensor 30, and third sensor 42 can measure one or more performance parameters of hydraulic circuit 24, including temperature, pressure, flow rate, acceleration, or shaft speed by way of non-limiting example.

First sensor 32 is connected to hydraulic circuit 24 between hydraulic pump 28 and fluid-powered device 26 on the output side of the hydraulic pump 28. In embodiments, first sensor 32 is a pressure sensor. This enables first sensor 32 to acquire output pressure measurements of fluid output from hydraulic pump 28 and provide the data to health monitoring system 100 through network 44.

Second sensor 30 is connected to hydraulic circuit 24 between hydraulic pump 28 and fluid-powered device 26 on the return side of the hydraulic pump 28. In embodiments, second sensor 30 is also a pressure sensor. This enables second sensor 30 to acquire pressure measurements, provide the return pressure data to health monitoring system 100 through network 44, and allow health monitoring system 100 to use the data in comparison with output pressure data from first sensor 32.

Third sensor 42 is coupled to case 40 and is communicative with health monitoring system 100 through network 44. In embodiments, third sensor 42 is a temperature sensor. Measurement data acquired by third sensor 42 can provide an inferential indication of the temperature of hydraulic fluid traversing hydraulic circuit 24. This data can be used by health monitoring system 100 to correct pressure measurements acquired by first sensor 32 and/or second sensor 30. Although illustrated with three sensors it is to be understood and appreciated that hydraulic system can have fewer or more sensors, as appropriate for a given application.

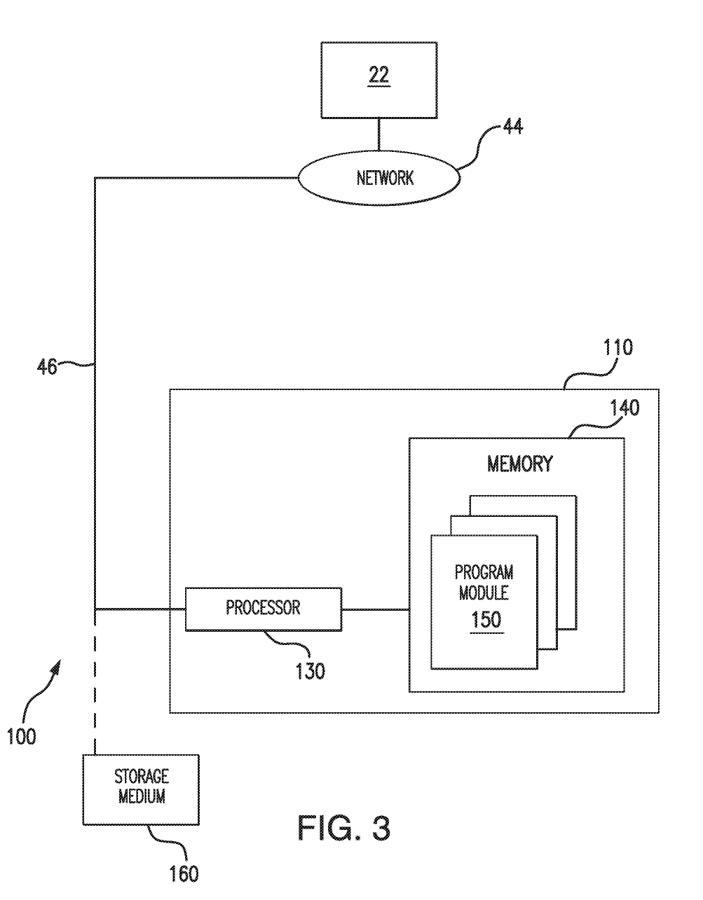

With reference to FIG. 3, health monitoring system 100 is shown. Health monitoring system 100 includes a computer 110 coupled to network 44. Network 44 in turn may include digital busses and/or aircraft radio networks associated with VTOL aircraft 10 (shown in FIG. 1). Computer 110 includes a processor 130 and a memory 140 having stored thereon a plurality of program modules 150. It is contemplated that memory 140 further includes (recorded thereon) data stored for analysis, such as through communication with a distributed health monitoring system or ground-based system for analysis. Although computer 110 is represented herein as a standalone device, it is not limited to such, but instead can be coupled to other devices (not shown) in a distributed processing system.

Processor 130 includes logic circuitry that responds to and executes instructions. Memory 140 includes a computer-readable medium encoded with a computer program. In this regard, memory 140 stores data and instructions readable and executable by processor 130 for controlling the operation of processor 130. Memory 140 may be implemented in a random access memory (RAM), a hard drive, a read only memory (ROM), or a combination thereof.

Program module 150 contains instructions for controlling processor 130 to execute the methods described herein. For example, under control of program module 150, processor 130 performs the processes described for health monitoring module 100 related above, such as receiving data from one or more sensors, manipulating the data, making determination regarding pump health in view of the data. It is to be appreciated that the term “module” is used herein to denote a functional operation that may be embodied either as a stand-alone component or as an integrated configuration of a plurality of sub-ordinate components. Thus, program module 150 may be implemented as a single module or as a plurality of modules that operate in cooperation with one another. Moreover, although program module 150 is described herein as being installed in memory 140, and therefore being implemented in software, it could be implemented in any of hardware (e.g., electronic circuitry), firmware, software, or a combination thereof.

Processor 130 outputs a result of an execution of the methods described herein. Alternatively, processor 130 could direct the output to a remote device (not shown), e.g., a flight operations center or off-aircraft diagnostic device, via network 44. It is also to be appreciated that while program module 150 is shown as loaded into memory 140, it may be configured on a storage medium 160 for subsequent loading into memory 140 via network 44 or via a wireless connection thereto (shown with dashed lines). Storage medium 160 is also a computer-readable medium encoded with a computer program, and can be any conventional storage medium that stores program module 150 thereon in tangible form. Examples of storage medium 160 include a floppy disk, a compact disk, a magnetic tape, a read only memory, an optical storage media, universal serial bus (USB) flash drive, a solid-state storage (SSD), a compact flash card, or a digital versatile disc. Alternatively, storage medium 160 can be a random access memory, or other type of electronic storage, located on a remote storage system and coupled to computer 110 via network 44. It is further to be appreciated that although the systems and methods described herein can be implemented in software, they could be implemented in any of hardware (e.g., electronic circuitry), firmware, software, or a combination thereof.

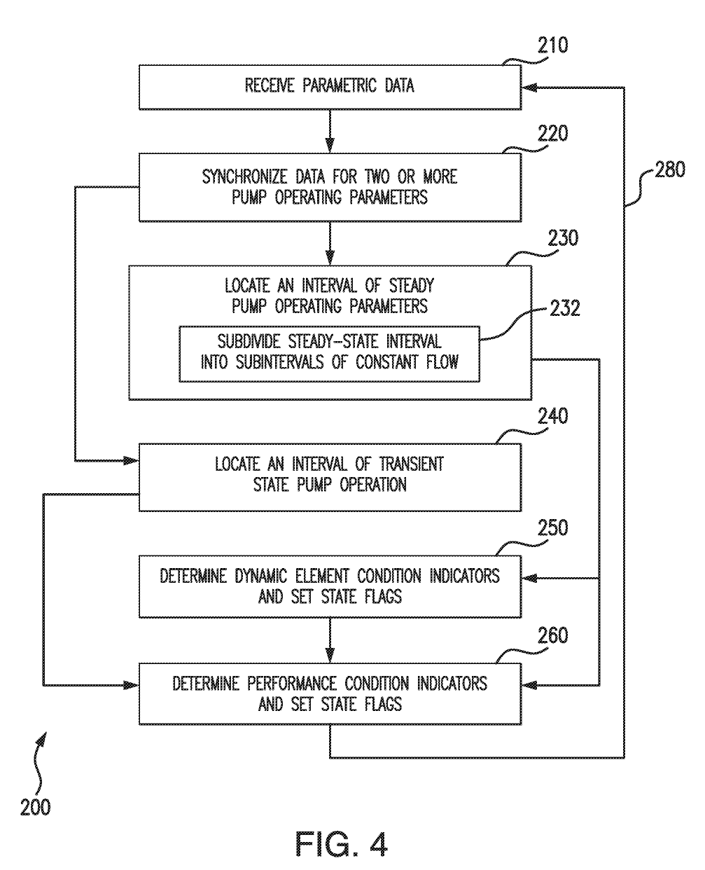

With reference to FIG. 4, a method 200 of monitoring heath of a hydraulic pump is shown. Method 200 includes receiving parametric data related to operation of a hydraulic pump, e.g. hydraulic pump 28, as shown with box 210. The received data is synchronized by relating two or more pump operating parameters with one another and time, as shown with box 220.

Method 200 additionally includes locating one or more intervals of steady state pump operation, shown with box 230. Method 200 may also include locating one or mare intervals of transient state pump operation, shown with box 240. Locating an interval of steady state (or transient state) operation can include using operational flag data output from an upstream module which is received as input data. Intervals of transient state operation may include pump startup and/or shutdown events, such as when a hydraulic pump coupled to a VTOL aircraft drive train is powered up prior to operation as well as following shutdown after operation. Intervals of steady state operation may include one or more periods of VTOL aircraft operation, and may be subdivided into one or more constant hydraulic flow subintervals, as shown by box 232. Intervals of steady state operation may be divided into subintervals of predetermined length, such as ‘windows’ of about one second each. Windowing allows for taking large sample sets of data available by sensors, e.g. first sensor 32 (shown in FIG. 2), second sensor 30 (shown in FIG. 2), and third sensor 42 (shown in FIG. 2), by subdividing steady state intervals into short time periods with a statistically significant number of measurements.

Method 200 additionally includes determining a plurality of indicators using data acquired from separate pump operational states. In this respect, method 200 additionally includes determining dynamic element indicators, e.g. of piston 34 (shown in FIG. 2), bearings, or other dynamic element of hydraulic pump 28 (shown in FIG. 2), shown with box 250, and determining performance indicators, shown with box 260. Method 200 can be repeated iteratively for a plurality of steady state and transient state intervals, as indicated with arrow 280.

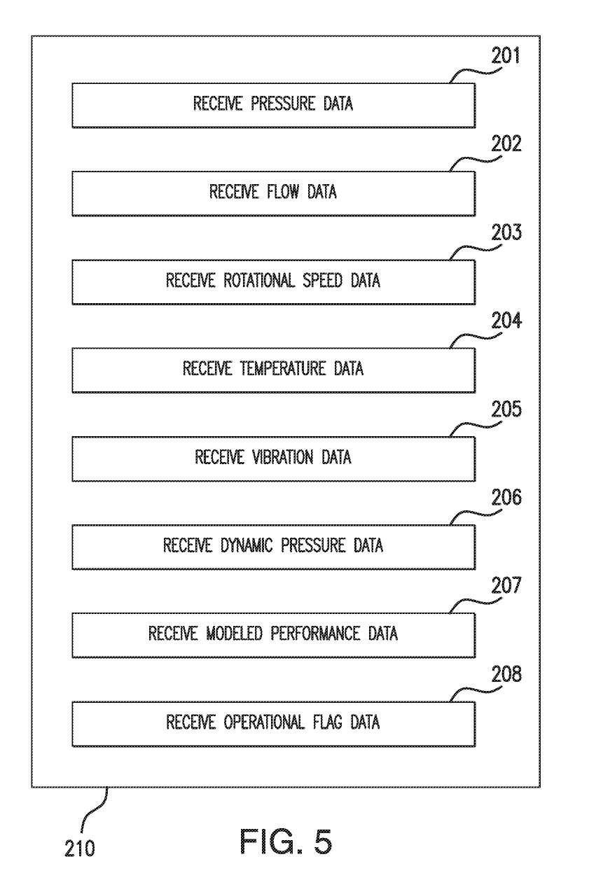

With reference to FIG. 5, receiving data 210 relating to the operation of a pump is shown. Receiving data may include receiving pressure data, such as from a pressure sensor disposed on a return side of the pump, e.g. second sensor 30 (shown in FIG. 2), and/or from a pressure sensor disposed on an output side of the pump, e.g. first sensor 32 (shown in FIG. 2), as shown with box 201. Receiving data may also include receiving flow data, as shown with box 202. Receiving data 210 may include receiving data indicative of pump shaft speed, e.g. shaft 38 (shown in FIG. 2), as shown with box 203. Receiving data 210 may include receiving temperature data indicative of the temperature of fluid within a hydraulic circuit, e.g. hydraulic circuit 24 (shown in FIG. 2), as shown with box 204. It is contemplated that the temperature data may be acquired from a sensor coupled to a pump case, e.g. third sensor 42 (shown in FIG. 2) coupled to case 40 (shown in FIG. 2).

Alternatively or additionally, receiving data 210 can include receiving vibration data associated with a dynamic element of a pump, shown with box 205. Examples of dynamic elements include piston 34, shaft 38, and input power source 36 (each shown in FIG. 2), or any other pump moving element. Receiving data 210 may include receiving modeled performance, as shown with box 207. As will be appreciated, modeled performance data include generalized (or illustrative) data representative of the expected operation with the type of pump incorporated in the hydraulic system subject to monitoring for temperature, pressure, and/or flow data input into the model. It is also contemplated receiving data 210 can include receiving operation flag data, shown by box 208.

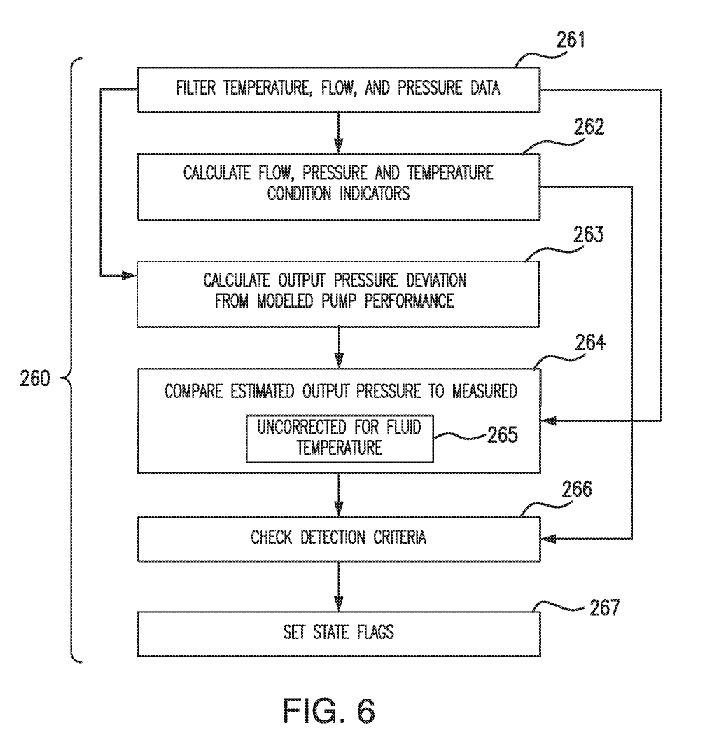

With reference to FIG. 6, operations associated with determining performance indicators are shown. Determining the performance indicators includes filtering temperature, flow, and pressure data, shown with box 261. One or more of the performance indicators can be checked against the predetermined detection criteria, shown with box 266, and one or mare state flags may be set, as shown with box 267.

Determining the performance indicators may include calculating pressure deviation between filtered pressure data and modeled pressure data, shown with box 263. The calculated pressure deviation may be checked by comparing the deviation with predetermined detection criteria, shown with box 266, and one or more state flags may be set using the comparison, as shown with box 267.

Determining the performance indicators can include calculating a difference between output pressure and estimated output pressure, as shown with box 264. The calculated difference can be uncorrected with respect to fluid temperature, thereby providing a tie to historical information relating pump performance based on measured and estimated output pressure differences, as shown with box 265. The calculated difference can be checked by comparing the difference with predetermined detection criteria, shown with box 266, and one or more state flags may be set using the comparison, as shown with box 267.

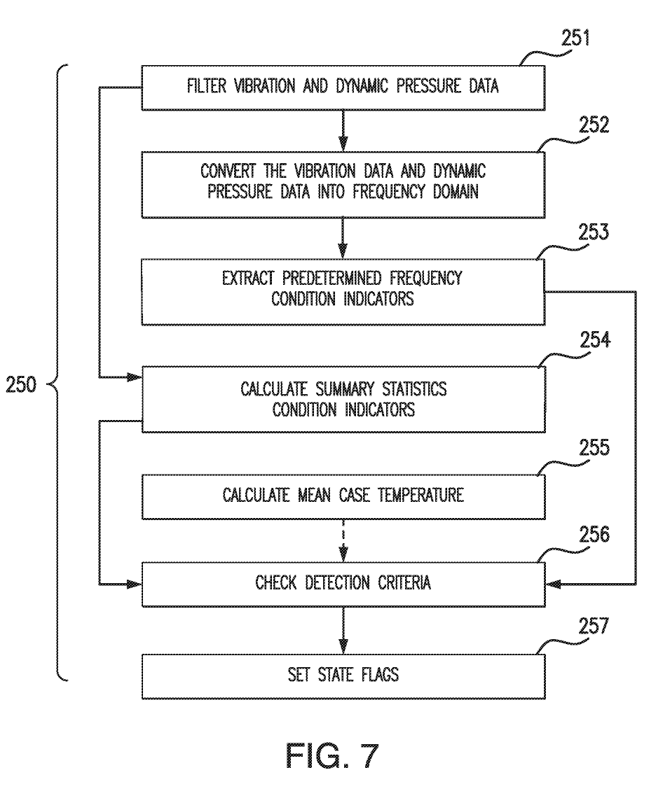

With reference to FIG. 7, operations associated with determining dynamic element condition indicators 250 are shown. Determining dynamic element condition indicators includes filtering vibration and dynamic pressure data, shown with box 251. Once filtered, the vibration and dynamic pressure data is converted into the frequency domain, shown with box 252, such as with a Fast Fourier Transform. Based on the frequency domain data, predetermined frequency condition indicators can be extracted, as shown with box 253. These condition indicators are then compared to predetermined detection criteria, as shown with box 256. Based on comparison of the extracted frequency condition indicators to predetermined detection criteria, one or more state flags are set, as shown with box 257.

Determining the dynamic element condition indicators can also include calculating summary statistics for filtered vibration and dynamic pressure data, as shown with box 254. As above, the summary statistics can characterize the complete interval of steady state operation or a subinterval, such as window of predetermined length or a subinterval where pump output exhibited a constant flow rate. Mean case temperature can also be calculated (shown with box 255) and applied to adjust or correct dynamic pressure readings based on inferential hydraulic fluid temperature associated with the case temperature measurements. The calculated parameters, i.e. measured frequency comparisons, summary statistics, and mean case temperatures, can thereafter be checked against predetermined thresholds for setting corresponding state flags.

In certain embodiments, all calculated parameters (condition indicators) are checked against detection criteria for setting state flags. There is no summation, fusion, combination, etc. of condition indicators to arrive at a single “dynamic element indicatory”. Instead, each condition indicator and corresponding state flag is returned from the module as output and can be applied in a downstream module.

Information upon which to base a decision to replace or service a hydraulic component like a pump can be sparse in certain applications, such as in VTOL aircraft. For that reason, faults are generally diagnosed by visual inspections and ground check test. In the case of hydraulic pumps associated with flight control systems, maintenance practices can be conservative, potentially causing unnecessary pump removals and/or replacements.

In embodiments described herein, a pump heath monitoring system and health monitoring method use measurement data obtained from hydraulic circuit sensors to generate condition indicators and diagnostic state flags indicative of a future change in pump reliability, e.g. an advance notice of a future change in hydraulic pump reliability. The systems and methods can be done on the aircraft, in real-time, or offline, using a diagnostic utility available to maintenance personnel.

In certain embodiments, the systems and method include two diagnostic algorithms. The first algorithm, pump performance diagnostics, monitors for pump performance departures from expected performance, e.g. when the pump output changes (decreases) for a given operating condition. This algorithm includes pump output pressure and flow data, and may also incorporate temperature information for the pump/hydraulic circuit. The second algorithm monitors pump dynamic elements, e.g. pump pistons, barrels, shafts, and hearings. These algorithms can enable detection of hydraulic system components with increased likelihood of future reliability change, and can potentially improve aircraft availability and/safety while reducing the need for inspections and diagnostic troubleshooting.

The systems and methods of the present disclosure, as described above and shown in the drawings, provide for health monitoring of hydraulic equipment with superior properties including prognostic assessment of incipient pumping efficiency changes. While the apparatus and methods of the subject disclosure have been shown and described with reference to VTOL, aircraft, those skilled in the art will readily appreciate the systems and methods described herein are applicable to hydraulic systems generally such as those found in fixed wing aircraft (e.g. flight control systems), ground vehicles (e.g. construction and mining equipment), robotics, and process control machinery. Those skilled in the art will also readily appreciate that changes and/or modifications may be made to embodiments described above without departing from the spirit and scope of the subject disclosure.

1. A computer-implemented method of monitoring a hydraulic system, comprising:
determining dynamic element indicators using data from an interval of steady state operation;
determining performance indicators using data from both the interval of steady state operation and an interval of transient state operation; and
setting one or more state flags using the dynamic element indicators and the performance indicators.

2. A method as recited in claim 1, further including:
receiving data associated with a plurality of pump operating parameters; and
synchronizing a first of the plurality of pump operating parameters with a second of the pump operating parameters.

3. A method as recited in claim 1, further including:
identifying, within data acquired from a sensor coupled to a hydraulic system, the interval of steady state operation and the interval of transient state operation.

4. A method as recited in claim 1, wherein determining the performance indicators includes calculating rotational speed at pressurization.

5. A method as recited in claim 1, wherein the data includes volumetric flow data, and including identifying a constant flow rate window within the interval of steady state operation.

6. A method as recited in claim 5, further including filtering the volumetric flow data, wherein identifying a constant flow rate window includes identifying the constant flow rate window using the filtered volumetric flow data.

7. A method as recited in claim 1, further including receiving temperature, flow, and pressure data, and filtering the temperature, flow, and pressure data.

8. A method as recited in claim 7, wherein determining the performance indicators includes determining the performance condition indicators using the filtered temperature, flow, and pressure data.

9. A method as recited in claim 7, further including receiving modeled pressure data, calculating modeled pressure using the received temperature, flow, and pressure data, and calculating a deviation between the calculated modeled pressure and the filtered pressure data.

10. A method as recited in claim 9, further including estimating output pressure based on pressure, temperature, and volumetric flow data, wherein determining the performance indicators includes using both (a) the deviation between the calculated modeled pressure data and filtered pressure data, and (b) a deviation between the calculated modeled pressure data corrected for temperature and the filtered pressure data.

11. A method as recited in claim 1, further including subdividing the interval of steady state operation into a plurality of subintervals having predetermined duration.

12. A method as recited in claim 2, wherein the received parametric data includes vibration and dynamic pressure data, and wherein determining a dynamic element indicators using data from the interval of steady state operation further includes:
converting the vibration and dynamic pressure data into frequency domain data;
extracting frequency domain vibration and dynamic pressure data associated with a pump dynamic element; and
comparing the extracted frequency domain vibration and dynamic pressure data with one or more detection criteria.

13. A method as recited in claim 12, further including calculating summary statistics for time domain vibration and dynamic pressure data, wherein determining the dynamic element indicators using data from the interval of steady state operation further includes comparing the calculated summary statistics to the one or more detection criteria.

14. A method as recited in claim 13, wherein the received data includes pump case temperature data, and further including:
calculating a mean case temperature, wherein determining the dynamic element indicators using data from the interval of steady state operation further includes comparing the mean case temperature to the one or more detection criteria.

15. A system for monitoring the health of hydraulic pump, comprising:
a processor and
a memory communicative with the processor and having instructions recorded thereon that, when read by the processor, cause the processor to:
determine dynamic element indicators using data from an interval of steady state operation;
determine a performance indicators using data from both the interval of steady state operation and the interval of transient state operation; and
set one or more state flags using the dynamic element indicators and the performance indicators.

16. A system as recited in claim 15, wherein the instructions further cause the processor to receive data associated with a plurality of pump operating parameters and synchronize a first of the plurality of pump operating parameters with a second of the pump operating parameters.

17. A system as recited in claim 15, wherein instructions further cause the processor to:
receive volumetric flow data;
identify a constant flow rate window within the interval of steady state operation; and
filter the volumetric flow data from within the identified constant flow rate window.

18. A system as recited in claim 15, wherein the instructions further cause the processor to:
receive temperature, flow, and pressure data;
filter the temperature, flow, and pressure data using filtering criteria stored on the memory;
determine the performance indicators using the filtered temperature, flow, and pressure data; and
set one or more state flags using the performance indicators.

19. A system as recited in claim 15, wherein the instructions further cause the processor to:
convert vibration and dynamic pressure data into frequency domain data;
extract frequency domain vibration information and dynamic pressure indicators associated with a dynamic element of the pump;
compare the extracted frequency domain vibration data and the dynamic pressure indicators with one or more detection criteria;
calculate statistics for the time domain vibration data and the dynamic pressure data;
compare the calculated statistics to the one or more detection criteria to determine corresponding state flags;
calculate a mean case temperature from received case temperatures;
determine a condition indicator by comparing the calculated mean case temperature to the one or more detection criteria; and
determine state flags corresponding to the dynamic element condition indicators.

20. A computer program product comprising a non-transitory, machine-readable medium having instructions recorded thereon that when read by a processor cause the processor to:
determine dynamic element indicators using data from an interval of steady state operation;
determine performance indicators using data from both the interval of steady state operation and an interval of transient state operation; and
set one or more state flags using the dynamic element indicators and the performance indicators.
